(19) United States
(12) Patent Application Publication
(10) Pub. No.: US 2013/0224604 A1
(43) Pub. Date: Aug. 29, 2013

(54) ELECTROLYTE FOR SECONDARY LITHIUM BATTERY AND SECONDARY LITHIUM BATTERY INCLUDING SAME

(71) Applicant: Samsung SDI Co., Ltd., (US)

(72) Inventors: Jung-Yi Yu, Yongin-City (KR); Woo-Cheol Shin, Yongin-City (KR); Sang-Il Han, Yongin-City (KR); Myung-Hwan Jeong, Yongin-City (KR); Tae-Hyun Bae, Yongin-City (KR); Moon-Sung KIM, Yongin-City (KR); Sang-Geun Kim, Yongin-City (KR); Maeng-Eun Lee, Yongin-City (KR); Jiten Singh, Yongin-City (KR)

(73) Assignee: SAMSUNG SDI CO., LTD., Yongin-City (KR)

(21) Appl. No.: 13/688,063

(22) Filed: Nov. 28, 2012

Related U.S. Application Data
(60) Provisional application No. 61/603,840, filed on Feb. 27, 2012.

(51) Int. Cl. H01M 10/0567

(52) U.S. Cl. CPC H01M 10/0567
USPC 429/331; 558/167; 429/339; 429/340; 429/341

(57) ABSTRACT

Disclosed is an electrolyte for a secondary lithium battery and a secondary lithium battery including the same, and the electrolyte includes an additive represented by Formula 1.

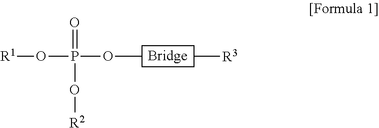

The definitions of each substituent in Formula 1 are the same as in the specification.

### CROSS-REFERENCE TO RELATED APPLICATIONS

This application claims priority to and the benefit of Provisional Patent Application No. 61/603, 840 filed in the U.S. Patent and Trademark Office on Feb. 27, 2012, the entire contents of which are incorporated herein by reference.

### BACKGROUND

1. Field

This disclosure relates to an electrolyte for a secondary lithium battery and a secondary lithium battery including the same.

2. Description of the Related Technology

Lithium secondary batteries have recently drawn attention as a power source for small portable electronic devices. They use an organic electrolyte solution and thereby have twice or more the discharge voltage than that of a conventional battery using an alkali aqueous solution, and accordingly have high energy density.

For positive active materials of a secondary lithium battery, lithium-transition element composite oxides capable of intercalating lithium, such as LiCoO₂, LiMn₂O₄, LiNi₁₋ₓCoₓO₂ (0<x<1), and the like, have been researched.

As for negative active materials of a secondary lithium battery, various carbon-based materials such as artificial graphite, natural graphite, and hard carbon, which can all intercalate and deintercalate lithium ions, have been used.

The electrolyte solution of a secondary lithium battery uses an organic solvent containing a lithium salt dissolved therein. Generally, a carbonate-based organic solvent where lithium ions are dissociated and transfer easily is usually used as the organic solvent.

### SUMMARY

One embodiment provides an electrolyte for a secondary lithium battery capable of improving cycle-life characteristics of a battery.

Another embodiment provides a secondary lithium battery including the electrolyte.

According to one embodiment, an electrolyte for a secondary lithium battery includes an additive represented by Formula 1.

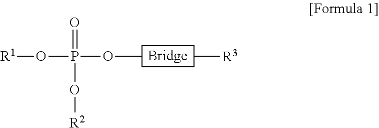

Herein, R¹ and R² are independently a substituted or unsubstituted alkyl group; a substituted or unsubstituted aromatic group; a halogen; a carbonyl group; an amine group; or a fluoroalky group,

Bridge is a substituted or unsubstituted C₂ to C₆ alkylene group; a substituted or unsubstituted C₅ to C₈ cycloalkylene group; or a substituted or unsubstituted aromatic group, and

R³ is CN; CONR⁴₂; or CONHR⁵, wherein R⁴ and R⁵ are independently a substituted or unsubstituted alkyl group; a substituted or unsubstituted aromatic group; a halogen; a carbonyl group; an amine group; or a fluoroalkyl group.

In another embodiment, R¹ and R² may each independently be a substituted or unsubstituted alkyl group; a substituted or unsubstituted aromatic group; a halogen; a carbonyl group; an amine group; or a fluoroalkyl group, and R³ may be CN.

According to another embodiment, provided is a secondary lithium battery that includes a negative electrode including a negative active material; a positive electrode including a positive active material; and an electrolyte including the additive represented by Formula 1.

The amount of the additive may be about 0.1 wt % to about 5 wt % based on the total weight of the electrolyte.

The non-aqueous organic solvent in the electrolyte may include a carbonate-based, ester-based, ether-based, ketone-based, or alcohol-based, aprotic solvent, or a combination thereof.

The electrolyte may further include vinylethyl carbonate, vinylene carbonate, or an ethylene carbonate-based compound of the following Formula 3.

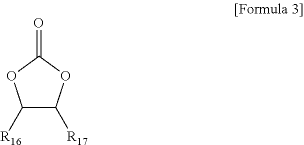

In Chemical Formula 3, R₁₆ and R₁₇ are each independently selected from the group consisting of hydrogen, a halogen, a cyano group (CN), a nitro group (NO₂), and a fluorinated C1 to C5 alkyl group, and at least one of R₁₆ and R₁₇ is selected from the group consisting of a halogen, a cyano group (CN), a nitro group (NO₂), and a fluorinated C1 to C5 alkyl group, provided that R₁₆ and R₁₇ are not simultaneously hydrogen.

The lithium salt may include LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(CyF_{2y+1}SO₂) wherein x and y are natural numbers, LiCl, LiI, LiB(C₂O₄)₂ (lithium bis(oxalato) borate; LiBOB), or a combination thereof.

Hereinafter, further embodiments will be described in detail.

The electrolyte for a secondary lithium battery according to one embodiment may improve the charge and discharge characteristics of the battery and may increase temperatures at which a reaction at an interface of the positive electrode starts.

### BRIEF DESCRIPTION OF THE DRAWINGS

FIG. 1 illustrates an outline of a lithium ion transfer mechanism in a secondary lithium battery in accordance with an embodiment.

FIG. 2 is a graph showing capacities according the charge and discharge cycles of the half-cells of Example 1 and Comparative Examples 1 and 2.

FIG. 3 is a graph showing discharge capacity retention calculated from the capacities according to the charge and discharge cycles in FIG. 2.

FIG. 4 is a graph showing capacities according the charge and discharge cycles of the half-cells of Example 2, and Comparative Example 1.

FIG. 5 is a graph showing discharge capacity retention calculated from the capacities according to the charge and discharge cycles in FIG. 4.

FIG. 6 is a graph showing capacities by varying charge and discharge rates of the secondary lithium cells according to Example 3 and Comparative Example 3.

FIG. 7 is a graph showing impedances of the secondary lithium cells according to Example 3 and Comparative Example 3.

FIG. 8 is a graph showing capacities depending on the various charge and discharge rates of the secondary lithium cells according to Reference Examples 1 to 3 and Comparative Example 4.

FIG. 9 is a graph showing direct current internal resistance (DC-IR) according to the cycles of the secondary lithium cells according to Reference Examples 1 to 3 and Comparative Example 4.

### DETAILED DESCRIPTION

Example embodiments of this disclosure will hereinafter be described in detail. However, these embodiments are examples, and this disclosure is not limited thereto.

One embodiment provides an electrolyte for a secondary lithium battery including an additive represented by Formula 1.

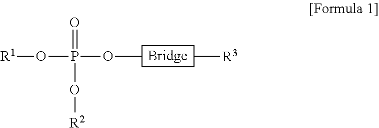

In Formula 1, R¹ and R² are independently a substituted or unsubstituted alkyl group; a substituted or unsubstituted aromatic group; a halogen; a carbonyl group; an amine group; or a fluoroalky group. R¹ and R² may be independently alkyls such as methyl, ethyl, propyl, butyl, isobutyl, and tertiary butyl; fluoroalkyl; trifluoroalkyl; phenyl; fluorophenyl; or fluorine, and more specifically methyl or trifluoromethyl.

The Bridge is a substituted or unsubstituted C₂ to C₆ alkylene group; a substituted or unsubstituted C₅ to C₈ cycloalkylene group; or a substituted or unsubstituted aromatic group. The Bridge may be tetramethylethylene, trifluoromethyltrimethylethylene, or tetratrifluoromethylethylene.

R³ is CN; CONR⁴₂; or CONHR⁵, wherein R⁴ and R⁵ are independently a substituted or unsubstituted alkyl group; a substituted or unsubstituted aromatic group; a halogen; a carbonyl group; an amine group; or a fluoroalkyl group. R⁴ and R⁵ are independently a substituted or unsubstituted alkyl group; a substituted or unsubstituted aromatic group; a halogen; a carbonyl; or a fluoroalkyl group. More specifically, R⁴ and R⁵ are independently a methyl or difluoromethyl.

In Formula 1, substituted groups in the substituted alkyl group, the substituted aromatic group, the substituted aromatic group, the substituted alkylene group, and the substituted cycloalkylene group may be an alkyl group, a halogen, an aromatic group, an amine group, an amide group, or a nitrile group. As used herein, when a specific definition is not otherwise provided, definition of each functional group is as follows.

As used herein, the term “alkyl group” may refer to a linear, branched, or cyclic alkyl group having C₁ to C₁₀ carbon.

As used herein, the “alkylene group” may refer to a linear or branched C₂ to C₁₂ alkylene group.

As used herein, the “cycloalkylene group” may refer to a C₃ to C₈ cycloalkylene group.

As used herein, the “aromatic group” may refer to a C₄ to C₆ aromatic group. Examples thereof may be benzene, pyran, hydropyran, furan, and hydrofuran.

As used herein, the “halogen” may refer to F, Cl, Br, or I.

If the Bridge is an alkylene group, the C₂ or more alkylene exhibits more improved discharge capacity retention, compared to a C₁ methylene group. If the bridge is a C₁ methylene, a carbon bonded to R³ has low atom density so it may be easily attacked by a nucleophilic agent, readily causing a chemical reaction prior to charging and discharging. However, the C₂ or more alkylene group may be more stable and have bulky functional groups compared to the methylene, so it is difficult to attack by the nucleophilic agent such that it rarely causes a chemical reaction prior to charging and discharging.

In one embodiment, one example of the additive may be 1-cyano-1,1,2,2-tetramethy dimethyl phosphate, 1-cyano-1,1,2,2-tetratrifluoromethyl dimethyl phosphate, 1-cyano-1,1-dimethyl-2,2-(trifluoromethyl) dimethyl phosphate, and 1-cyano-1,1-di(trifluoromethyl)-2,2-dimethyl dimethyl phosphate.

Since the additive for an electrolyte according to one embodiment represented by Formula 1 has both a cyano group or amide group and a phosphate group in one molecule, a stable SEI (solid electrolyte interface) layer may be formed on a surface of a negative electrode when a battery with the additive is charged and discharged. Accordingly, the additive for an electrolyte according to one embodiment may repress cycle-life characteristic fading due to shrinkage and expansion of the negative active material during charge and discharge, thereby improving the cycle-life characteristic of the secondary lithium battery. The additive may reduce resistance during charging and discharging, thereby improving rate capability.

The electrolyte including the additive may include a non-aqueous organic solvent and a lithium salt. The amount of the additive may be about 0.05 wt % to about 5 wt % based on the total weight of the electrolyte, and in another embodiment, about 0.1 wt % to about 2 wt %. When the amount of the additive falls in the above range, it may further improve the cycle-life characteristic and further reduce resistance at the interface which allows an improvement in power characteristics.

The non-aqueous organic solvent serves as a medium for transferring ions taking part in the electrochemical reaction of the battery.

The non-aqueous organic solvent may include a carbonate-based, ester-based, ether-based, ketone-based, alcohol-based, or aprotic solvent.

Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Examples of the ester-based solvent may include methyl acetate, ethyl acetate, n-propyl acetate, dimethyl acetate, methylpropionate, ethylpropionate, γ-butyrolactone, decanolide, valerolactone, mevalonolactone, caprolactone, and the like.

Examples of the ether-based solvent include dibutyl ether, tetraglyme, diglyme, dimethoxyethane, 2-methyltetrahydrofuran, tetrahydrofuran, and the like, and examples of the ketone-based solvent include cyclohexanone and the like.

Examples of the alcohol-based solvent include ethanol, isopropyl alcohol, and so on, and examples of the aprotic solvent include nitriles such as T-CN, wherein T is a C2 to C20 linear, branched, or cyclic hydrocarbon, or includes a double bond, an aromatic ring, or an ether bond, amides such as dimethylformamide, dioxolanes such as 1,3-dioxolane, sulfolanes, and the like.

The non-aqueous organic solvent may be used singularly or in a mixture. When the organic solvent is used in a mixture, the mixing ratio may be controlled in accordance with a desirable battery performance.

The carbonate-based solvent may include a mixture of a cyclic carbonate and a linear carbonate. The cyclic carbonate and the linear carbonate are mixed together at a volume ratio of about 1:1 to about 1:9, and when the mixture is used as an electrolyte, the electrolyte performance may be enhanced.

In addition, the non-aqueous organic solvent may further include mixtures of carbonate-based solvents and aromatic hydrocarbon-based solvents.

The carbonate-based solvents and the aromatic hydrocarbon-based solvents may be mixed together at a volume ratio of about 1:1 to about 30:1.

The aromatic hydrocarbon-based organic solvent may be represented by the following Formula 2.

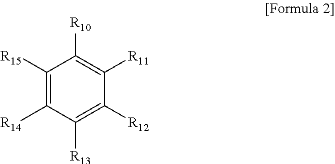

In Chemical Formula 9, R₁₀ to R₁₅ are the same or different and are selected from the group consisting of hydrogen, a halogen, a C1 to C10 alkyl group, a C1 to C10 haloalkyl group, and a combination thereof.

The aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte for a secondary lithium battery may further include vinylethyl carbonate, vinylene carbonate, or an ethylene carbonate-based compound of the following Formula 3 as a material for improving the cycle-life characteristic, in order to improve the cycle-life of a battery.

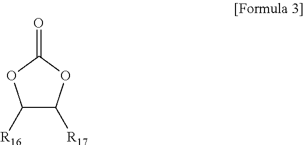

In Chemical Formula 3, R₁₆ and R₁₇ are each independently selected from the group consisting of hydrogen, a halogen, a cyano group (CN), a nitro group (NO₂), and a fluorinated C₁ to C₅ alkyl group, and at least one of R₁₆ and R₁₇ is selected from the group consisting of hydrogen, a halogen, a cyano group (CN), a nitro group (NO₂), and a fluorinated C₁ to C₅ alkyl group, provided that R₁₆ and R₁₇ are not simultaneously hydrogen.

The ethylene carbonate-based compound may include difluoroethylene carbonate, chloroethylene carbonate, dichloroethylene carbonate, bromoethylene carbonate, dibromoethylene carbonate, nitroethylene carbonate, cyanoethylene carbonate, or fluoroethylene carbonate, and the like.

In one embodiment, when the additive represented by Formula 1 is used together with the material for improving the cycle-life characteristic, the cycle-life characteristic may be more improved. The amount of the material for improving the cycle-life characteristic may about 50 parts by weight to about 5000 parts by weight based on 100 parts by weight of the additive represented by Formula 1. When the amount of the material for improving the cycle-life characteristic is within the above range, the resistance at the interface may be more suitably maintained and a more improved long cycle-life characteristic may be obtained.

The lithium salt dissolved in an organic solvent supplies lithium ions in the battery, operates a basic operation of a secondary lithium battery, and improves lithium ion transport between positive and negative electrodes.

Examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(CyF_{2y+1}SO₂) wherein x and y are natural number, LiCl, LiI, and LiB(C₂O₄)₂ (lithium bis(oxalato) borate; LiBOB).

The lithium salt may be used at a 0.1 to 2.0 M concentration. When the lithium salt is included in the above concentration range, electrolyte performance and lithium ion mobility may be enhanced due to optimal electrolyte conductivity and viscosity.

According to another embodiment, a secondary lithium battery includes a negative electrode, including a negative active material, a positive electrode including a positive active material, and the electrolyte including the additive represented by Formula 1.

The negative electrode includes a current collector and a negative active material layer formed on the current collector and including a negative active material.

A material that reversibly intercalates/deintercalates lithium ions, a lithium metal, a lithium metal alloy, a material capable of doping and dedoping lithium, or a transition metal oxide may be used as the negative active material.

The material that reversibly intercalates/deintercalates lithium ions includes carbon-based materials. The carbon-based material may be any generally-used carbon-based negative active material used in a secondary lithium battery. Examples of the carbon-based negative active material include crystalline carbon, amorphous carbon, and a mixture thereof. The crystalline carbon may be non-shaped, or sheet-, flake-, spherical-, or fiber-shaped natural graphite or artificial graphite. The amorphous carbon may be a soft carbon, a hard carbon, a mesophase pitch carbonized product, fired coke, and the like.

Examples of the lithium metal alloy include lithium and a metal selected from the group consisting of Na, K, Rb, Cs, Fr, Be, Mg, Ca, Sr, Si, Sb, Pb, In, Zn, Ba, Ra, Ge, Al, and Sn.

Examples of the material capable of doping and dedoping lithium include Si, SiOₓ (0<x<2), a Si-Q alloy (wherein Q is an element selected from the group consisting of an alkali metal, an alkaline-earth metal, a Group 13 element, a Group 14 element, a Group 15 element, a Group 16 element, a transition element, a rare earth element, and a combination thereof, and is not Si), a Si-carbon composite, Sn, SnO₂, a Sn—R alloy (wherein R is an element selected from the group consisting of an alkali metal, an alkaline-earth metal, a Group 13 element, a Group 14 element, a Group 15 element, a Group 16 element, a transition element, a rare earth element, and a combination thereof, and is not Sn), a Sn-carbon composite, and the like. At least one of these materials may be mixed with SiO₂.

The elements Q and R may be one selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and a combination thereof.

Examples of the transition metal oxide include lithium titanium oxide.

The negative active material layer includes the negative active material and a binder, and optionally a conductive material.

The negative active material layer may include about 95 wt % to about 99 wt % of a negative active material based on the total weight of the negative active material layer. The negative active material layer may include about 1 wt % to about 5 wt % of a binder based on the total weight of the negative active material layer.

When the negative active material layer further includes a conductive material, the negative active material layer may include about 90 wt % to about 98 wt % of a negative active material, about 1 to about 5 wt % of a binder, about 1 wt % to about 5 wt % of a conductive material.

The binder improves binding properties of the negative active material particles to each other and to a current collector. The binder may include a non-water-soluble binder, a water-soluble binder, or a combination thereof.

The non-water-soluble binder may include polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

The water-soluble binder includes a styrene-butadiene rubber, an acrylated styrene-butadiene rubber, polyvinyl alcohol, sodium polyacrylate, a copolymer of propylene and a C2 to C8 olefin, a copolymer of (meth)acrylic acid and (meth)acrylic acid alkyl ester, or a combination thereof.

When the water-soluble binder is used as a negative electrode binder, a cellulose-based compound may be further used to provide viscosity. The cellulose-based compound includes one or more of carboxylmethyl cellulose, hydroxypropylmethyl cellulose, methyl cellulose, or alkali metal salts thereof. The alkali metal may be Na, K, or Li.

The cellulose-based compound may be included in an amount of about 0.1 parts to about 3 parts by weight based on 100 parts by weight of the negative active material.

The conductive material may be included to improve electrode conductivity. Any electrically conductive material may be used as a conductive material unless it causes a chemical change. Examples of the conductive material include a carbon-based material such as natural graphite, artificial graphite, carbon black, acetylene black, ketjen black, a carbon fiber, and the like; a metal-based material such as a metal powder or a metal fiber of copper, nickel, aluminum, silver, and the like; a conductive polymer such as polyphenylene derivative; or a mixture thereof.

The negative active material layer may be formed through a method including: mixing a negative active material, a binder, and optionally a conductive material in a solvent to prepare a negative active material composition, and coating a current collector with the negative active material composition.

Since the method of forming the negative active material layer is well known, it is not described in detail in the present specification.

The solvent may be N-methylpyrrolidone but it is not limited thereto. When the negative active material layer includes a water-soluble binder, the negative active material composition may be prepared using water as a solvent.

The current collector may include a copper foil, a nickel foil, a stainless steel foil, a titanium foil, a nickel foam, a copper foam, a polymer substrate coated with a conductive metal, or combinations thereof.

The positive electrode includes a current collector and a positive active material layer disposed on the current collector. The positive active material includes lithiated intercalation compounds that reversibly intercalate and deintercalate lithium ions. Examples of the lithiated intercalation compounds may be one of the compounds of the following Chemical Formulas:

LiₐA_{1-b}X_{b}D₂ (0.90≦a≦1.8, 0≦b≦0.5); LiₐA_{1-b}X_{b}O_{2-c}D_{c} (0.90≦a≦1.8, 0≦b≦0.5, 0≦c≦0.05); LiₐE_{1-b}X_{b}O_{2-c}D_{c} (0.90≦a≦1.8, 0≦b≦0.5, 0≦c≦0.05); LiₐE_{2-b}X_{b}O_{4-c}D_{c} (0.90≦a≦1.8, 0≦b≦0.5, 0≦c≦0.05); LiₐNi_{1-b-c}Co_{b}X_{c}D_{α} (0.90≦a≦1.8, 0≦b≦0.5, 0≦c≦0.5, 0<α≦2); LiₐNi_{1-b-c}Co_{b}X_{c}O2-αT_{α} (0.90≦a≦1.8, 0≦b≦0.5, 0≦c≦0.05, 0<α<2); LiₐNi_{1-b-c}Co_{b}X_{c}O_{2-α}T₂ (0.90≦a≦1.8, 0≦b≦0.5, 0≦c≦0.05, 0<α<2); LiₐNi_{1-b-c}Mn_{b}X_{c}D_{α} (0.90≦a≦1.8, 0≦b≦0.5, 0≦c≦0.05, 0<α≦2); LiₐNi_{1-b-c}Mn_{b}X_{c}O_{2-α}T_{α} (0.90≦a≦1.8, 0≦b≦0.5, 0≦c≦0.05, 0<α<2); LiₐNi_{1-b-c}Mn_{b}X_{c}O_{2-α}T₂ (0.90≦a≦1.8, 0≦b≦0.5, 0≦c≦0.05, 0<α<2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GₑO₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦b≦0.1) LiₐCoG_{b}O₂ (0.90≦a≦1.8, 0.001≦b≦0.1); LiₐMn_{1-b}G_{b}O₂ (0.90≦a≦1.8, 0.001≦b≦0.1); LiₐMn₂G_{b}O₄ (0.90≦a≦1.8, 0.001≦b≦0.1); LiₐMn_{1-g}G_{g}PO₄ (0.90≦a≦1.8, 0≦g≦0.5); QO₂; QS₂; LiQS₂; V₂O₅; LiV₂O₅; LiZO₂; LiNiVO₄; Li_{(3-f)}J₂(PO₄)₃ (0≦f≦2); Li_{(3-f)}Fe₂(PO₄)₃ (0≦f≦2); and LiₐFePO₄ (0.90≦a≦1.8).

In the above Chemical Formulas, A is selected from the group consisting of Ni, Co, Mn, and a combination thereof; X is selected from the group consisting of Al, Ni, Co, Mn, Cr, Fe, Mg, Sr, V, a rare earth element, and a combination thereof; D is selected from the group consisting of O, F, S, P, and a combination thereof; E is selected from the group consisting of Co, Mn, and a combination thereof; T is selected from the group consisting of F, S, P, and a combination thereof; G is selected from the group consisting of Al, Cr, Mn, Fe, Mg, La, Ce, Sr, V, and a combination thereof; Q is selected from the group consisting of Ti, Mo, Mn, and a combination thereof; Z is selected from the group consisting of Cr, V, Fe, Sc, Y, and a combination thereof; and J is selected from the group consisting of V, Cr, Mn, Co, Ni, Cu, and a combination thereof.

The compound may have a coating layer on the surface thereof, or may be mixed with another compound having a coating layer. The coating layer may include at least one coating element compound selected from the group consisting of an oxide of a coating element, a hydroxide of a coating element, an oxyhydroxide of a coating element, a carbon oxide of a coating element, and a hydroxyl carbonate of a coating element.

The compound for a coating layer may be amorphous or crystalline.

The coating element included in the coating layer may include Mg, Al, Co, K, Na, Ca, Si, Ti, V, Sn, Ge, Ga, B, As, Zr, or a mixture thereof.

The coating layer may be formed in a method having no adverse influence on properties of a positive active material by including these elements in the compound. For example, the method may include any coating method such as spray coating, dipping, and the like, but is not illustrated in more detail, since it is well-known to those who work in the related field.

In the positive active material layer, the positive active material may be included in an amount of about 90 wt % to about 98 wt % based on the total weight of the positive active material layer.

The positive active material layer ma y further include a binder and a conductive material.

The binder and the conductive material may be included in an amount of about 1 wt % to about 5 wt %, based on the total weight of the positive active material layer, respectively.

The binder improves binding properties of positive active material particles to one another and to a current collector. Examples of the binder include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material may be included to improve electrode conductivity. Any electrically conductive material may be used as a conductive material, unless it causes a chemical change.

Examples of the conductive material include: a carbon-based material such as natural graphite, artificial graphite, carbon black, acetylene black, ketjen black, carbon fiber, and the like; a metal-based material including a metal powder or a metal fiber of copper, nickel, aluminum, silver, and the like; a conductive polymer such as a polyphenylene derivative; or a mixture thereof.

The current collector may be Al, but is not limited thereto.

The positive electrode may be fabricated by a method including mixing a positive active material, a conductive material, and a binder in a solvent to prepare a positive active material composition, and coating the positive active material composition on a current collector.

The electrode manufacturing method is well known and is thus not described in detail in the present specification. The solvent includes N-methylpyrrolidone and the like, but is not limited thereto.

The secondary lithium battery may further include a separator between the negative electrode and positive electrode, if needed.

Such a separator may comprise polyethylene, polypropylene, polyvinylidene fluoride, or multi-layers thereof such as a polyethylene/polypropylene double-layered separator, a polyethylene/polypropylene/polyethylene triple-layered separator, and a polypropylene/polyethylene/polypropylene triple-layered separator.

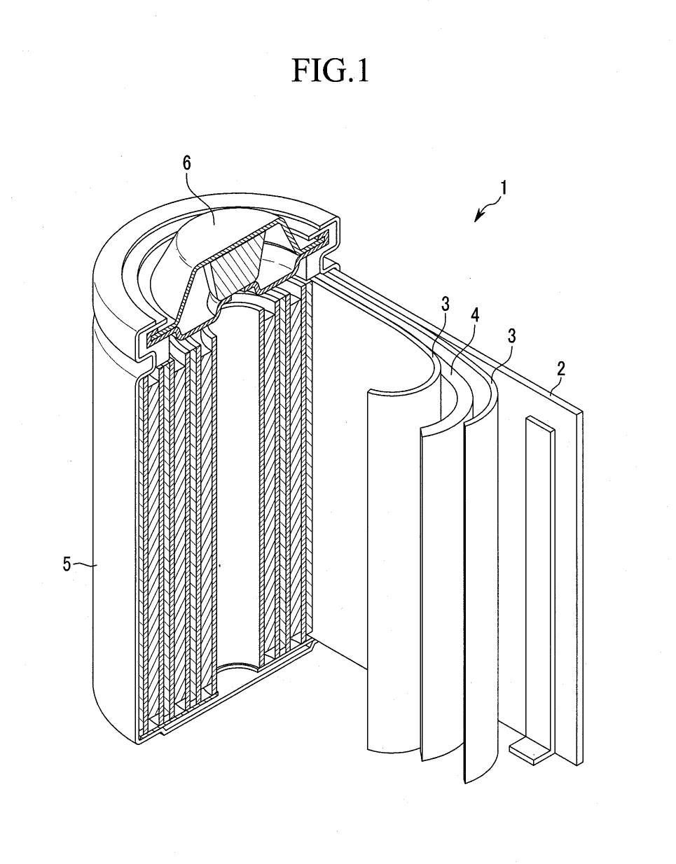

FIG. 1 is a schematic view of a representative structure of a secondary lithium battery. As illustrated in FIG. 1, the secondary lithium battery 1 includes a battery case 5 including a positive electrode 3, a negative electrode 2, and a separator 4 interposed between the positive electrode 3 and negative electrode 2, an electrolyte impregnated therein, and a sealing member 6 sealing the battery case 5.

The following examples illustrate the present embodiments in more detail. These examples, however, should not in any sense be interpreted as limiting the scope of the present embodiments.

### EXAMPLE 1

A LiPF₆ lithium salt was added to a mixed non-aqueous organic solvent including ethylene carbonate (EC), ethylmethyl carbonate (EMC), and dimethyl carbonate (DMC) at a volume ratio of EC/EMC/DMC of 3/4/3, and an additive represented by Formula 1a was added thereto, preparing an electrolyte for a secondary lithium battery. At this time, the concentration of the lithium salt was 1.3 M, and the amount of the additive was 0.5 wt % based on the total weight of the electrolyte.

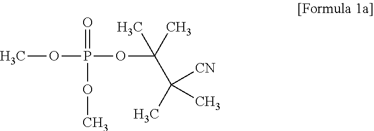

### EXAMPLE 2

A LiPF₆ lithium salt was added to a mixed non-aqueous organic solvent including ethylene carbonate (EC), ethylmethyl carbonate (EMC), and dimethyl carbonate (DMC) at a volume ratio of EC/EMC/DMC of 3/4/3, and an additive represented by Formula 1a and fluoroethylene carbonate were added thereto, preparing an electrolyte for a secondary lithium battery. At this time, the concentration of the lithium salt was 1.3 M and the amount of the additive was 0.2 wt % based on total weight of the electrolyte. Furthermore, the amount of the fluoroethylene carbonate was 5 wt % based on the total weight of the electrolyte, e.g., 2500 parts by weight based on 100 parts by weight of the additive.

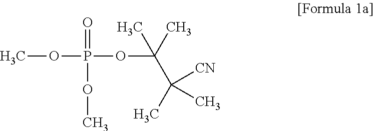

### COMPARATIVE EXAMPLE 1

A LiPF₆ lithium salt was added to a mixed non-aqueous organic solvent including ethylene carbonate (EC), ethylmethyl carbonate (EMC), and dimethyl carbonate (DMC) at a volume ratio of EC/EMC/DMC of 3/4/3, preparing an electrolyte for a secondary lithium battery. At this time, the concentration of the lithium salt was 1.3 M.

### COMPARATIVE EXAMPLE 2

A LiPF₆ lithium salt was added to a mixed non-aqueous organic solvent including ethylene carbonate (EC), ethylmethyl carbonate (EMC), and dimethyl carbonate (DMC) at a volume ratio of EC/EMC/DMC of 3/4/3, and an additive represented by Formula 5 was added thereto, preparing an electrolyte for a secondary lithium battery. At this time, the concentration of the lithium salt was 1.3 M and the amount of the additive was 0.5 wt % based on the total weight of the electrolyte.

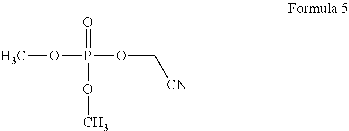

### Capacity Retention

Coin-type full cells were fabricated using the electrolytes according to Examples 1 and 2 and Comparative Examples 1 and 2. In the full cells, a positive electrode with a LiNi_{0.4}Co_{0.3}Mn_{0.3}O₂ positive active material was used, and a negative electrode including a graphite negative active material was used.

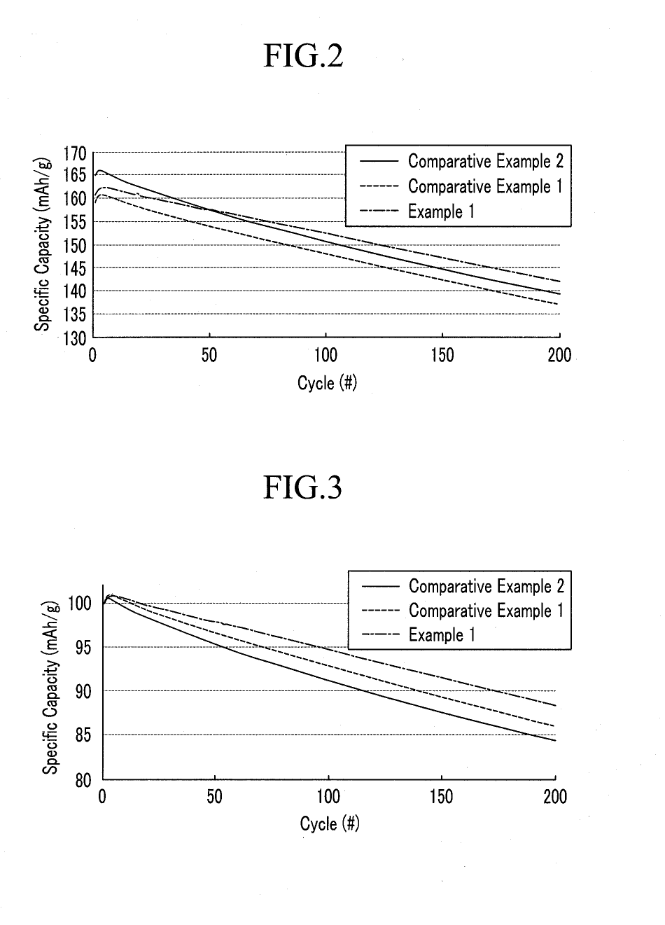

The cells using the electrolytes according to Example 1 and Comparative Examples 1 and 2 among the fabricated cells were charged and discharged at 1 C 200 times, and the discharge capacity at each cycle was measured. The results are shown in FIG. 2. Furthermore, the discharge capacity retention is obtained by calculating the discharge capacity shown in FIG. 2 as a percent (%) based on the initial discharge capacity, and the results are shown in FIG. 3.

As shown in FIGS. 2 and 3, the cell according to Example 1 using the electrolyte including the additive highly maintains discharge capacity, compared to that according to Comparative Example 1.

Furthermore, the cell according to Example 1 exhibits slightly lower discharge than that according to Comparative Example 2, at an initial stage, but exhibits less discharge capacity fading as cycles are repeated. The cell according to Example 1 exhibits better capacity retention than that according to Comparative Example 2. From these results, it is clearly evident that the additive in which the bridge is an ethyl in Formula 1 may more improve the capacity retention of the battery as cycles are repeated than the additive in which the bridge is a methyl.

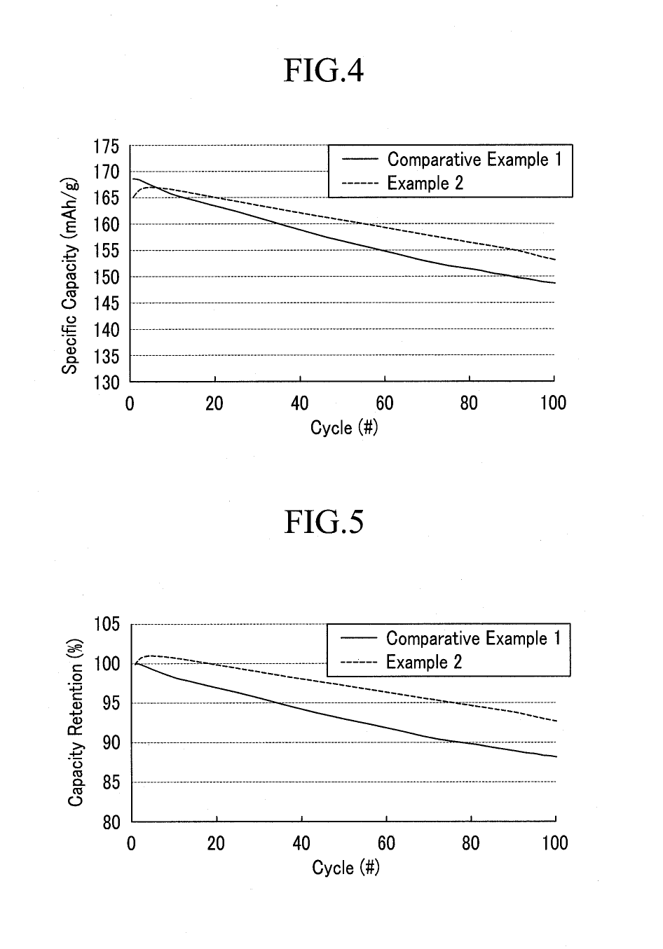

The cells according to Example 2 and Comparative Example 1 were charged and discharged at 1 C 100 times, and the discharge capacity was measured. The results are shown in FIG. 4. Furthermore, the discharge capacity retention is obtained by calculating the discharge capacity shown in FIG. 3 as a percent (%) based on the initial discharge capacity, and the results are shown in FIG. 5.

As shown in FIG. 4, the cell according to Example 2 exhibits slightly lower discharge than that according to Comparative Example 1 at an initial stage, but exhibits less discharge capacity fading as cycles are repeated. Furthermore, as shown in FIG. 5, the cell according to Example 2 exhibits better capacity retention than that according to Comparative Example 1 in all cycle regions.

Comparing FIGS. 2 and 4, the cell according to Example 2 exhibits higher initial charge and discharge capacity and capacity retention as cycles are repeated, compared to that according to Example 1. From these result, it is evident that the use of the additive represented by Formula 1a together with fluoroethylene carbonate gives more improved discharge capacity retention.

### EXAMPLE 3

A LiPF₆ lithium salt was added to a mixed non-aqueous organic solvent including ethylene carbonate (EC), ethylmethyl carbonate (EMC), and dimethyl carbonate (DMC) at a volume ratio of EC/EMC/DMC of 2/2/6, and an additive represented by Formula 1a was added thereto, preparing an electrolyte for a secondary lithium battery. At this time, the concentration of the lithium salt was 1.3 M and the amount of the additive was 1 wt % based on the total weight of the electrolyte.

A mixed positive active material of Li₂MnO₃ and LiNi_{0.5}Co_{0.2}Mn_{0.3}O₂ (50:50 wt %), a denka black conductive agent, and a polyvinylidene fluoride binder were mixed in N-methyl pyrrolidone at a weight ratio of 90:6:4 to prepare a positive active material slurry. The positive active material slurry was coated on an Al foil current collector, to produce a positive electrode. At this time, the active mass density was 3.40 g/cc and the loading level (L/L) was 20.54 mg/cm².

A silicon carbon nano-composite (ICG10H, Mitsubishi Chemical) as a negative active material, styrene-butadiene rubber as a binder, and carboxylmethyl cellulose as an agent for increasing viscosity were dispersed in water at a weight ratio of 97.5:1:1.5, to prepare a negative active material slurry.

The negative active material slurry was coated on a Cu foil current collector to produce a negative electrode. At this time, the active mass density was 1.50 g/cc and the loading level (L/L) was 11.18 mg/cm².

Using the positive electrode, the negative electrode, the electrolyte, and a separator, a secondary lithium cell was fabricated. As the separator, a three-layered film (polypropylene/polyethylene/polypropylene, Trade name: Celgard 2320) with a thickness of 20 μm was used.

### COMPARATIVE EXAMPLE 3

A secondary lithium cell was fabricated by the same procedure as in Example 3, except that the additive represented by Formula 1a was not used.

### Rate Capability

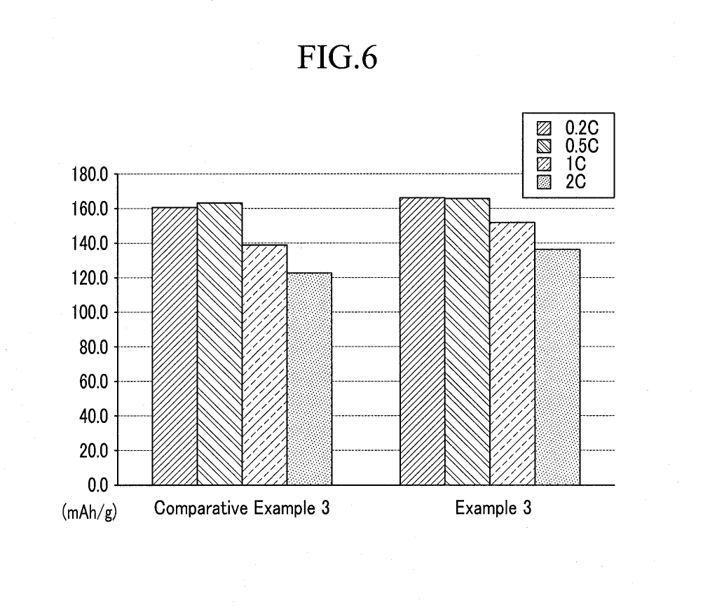

The secondary lithium cells according to Example 3 and Comparative Example 3 were charged and discharged at 0.2 C, 0.5 C, 1 C, and 2 C once, respectively, and the discharge capacities were measured. The results are shown in FIG. 6. As shown in FIG. 6, the cell according to Example 3 exhibits good discharge capacity compared to that according to Comparative Example 3, and better discharge capacity at high rates compared to that according to Comparative Example 3.

### Resistance Measurement

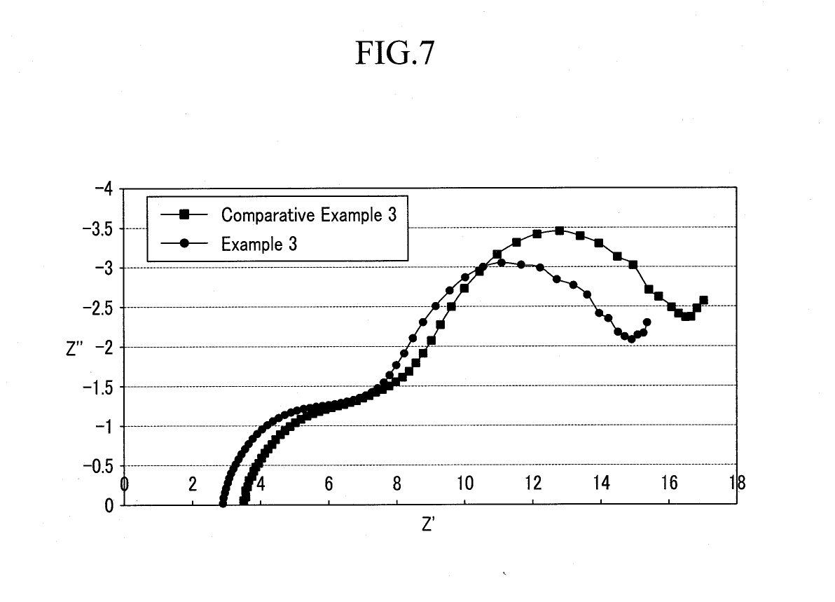

The impedances for the secondary lithium cells according to Example 3 and Comparative Example 3 were measured. The results are shown in FIG. 7. The results in FIG. 7 indicate that the resistance of the secondary lithium cell according to Example 3 is lower than that according to Comparative Example 3. From these results, it is expected that the SEI layer on the negative electrode of the secondary lithium cell according to Example 3 is more stable and has lower resistance than the SEL layer of that according to Comparative Example 3.

### EXAMPLE 4

A LiPF₆ lithium salt was added to a mixed non-aqueous organic solvent including ethylene carbonate (EC), ethylmethyl carbonate (EMC), and dimethyl carbonate (DMC) at a volume ratio of EC/EMC/DMC of 2/2/6, and an additive represented by Formula 1a was added thereto, preparing an electrolyte for a secondary lithium battery. At this time, the concentration of the lithium salt was 1.3 M and the amount of the additive was 0.1 wt % based on the total weight of the electrolyte.

An m-NCM56/22/22 (LiNi_{0.5}Co_{0.2}Mn_{0.3}O₂) positive active material, a denka black conductive agent, and a polyvinylidene fluoride binder were mixed in N-methyl pyrrolidone at a weight ratio of 92:4:4, to prepare a positive active material slurry. The positive active material slurry was coated on an Al foil current collector to produce a positive electrode. At this time, the active mass was 3.40 g/cc and the loading level (L/L) was 20.54 mg/cm².

A silicon carbon nano-composite (ICG10H, Mitsubishi Chemical) as a negative active material, styrene-butadiene rubber as a binder, and carboxylmethyl cellulose as an agent for increasing viscosity were dispersed in water at a weight ratio of 97.5:1:1.5, to prepare a negative active material slurry.

The negative active material slurry was coated on a Cu foil current collector to produce a negative electrode. At this time, the active mass density was 1.50 g/cc and the loading level (L/L) was 11.18 mg/cm².

Using the positive electrode, the negative electrode, the electrolyte, and a separator, a secondary lithium cell was fabricated. As the separator, a three-layered film (polypropylene/polyethylene/polypropylene, Trade name: Celgard 2320) with a thickness of 20 μm was used.

### EXAMPLE 5

A secondary lithium cell was fabricated by the same procedure as in Example 4, except that the additive represented by Formula 1a was used in an amount of 0.5 wt %.

### EXAMPLE 6

A secondary lithium cell was fabricated by the same procedure as in Example 4, except that the additive represented by Formula 1a was used in an amount of 1 wt %.

### EXAMPLE 6

A secondary lithium cell was fabricated by the same procedure as in Example 4, except that the additive represented by Formula 1a was not used.

### Rate Capability

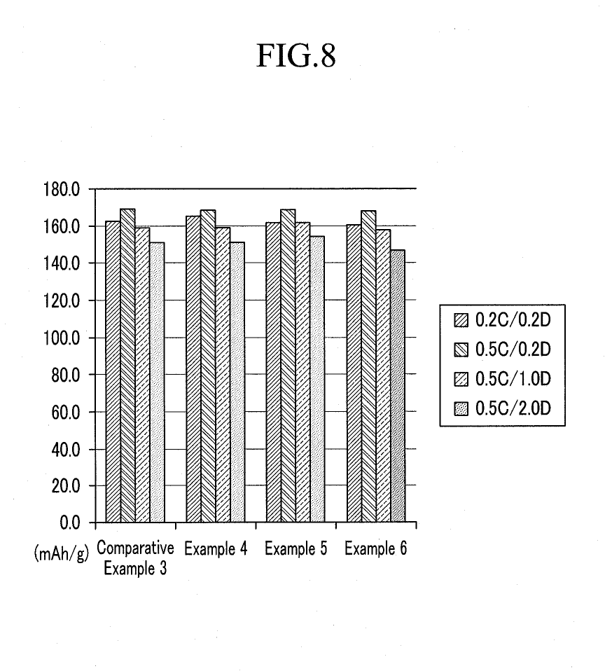

The secondary lithium cells according to Examples 4 to 6 and Comparative Example 3 were charged at 0.2 C and discharged at 0.2 C, charged at 0.5 C and discharged at 0.2 C, charged at 0.5 C and discharged at 1.0 C, and charged at 0.5 C and discharged at 2.0 C, once, respectively. The discharge capacities were measured. The results are shown in FIG. 8.

As shown in FIG. 8, the rate capability of the cells was improved by adding the additive represented by Formula 1. The cell according to Example 4 using 0.1 wt % of the additive exhibits slightly similar rate capability to that according to Comparative Example 3, but slightly higher at low rate (0.2 C charge/0.2 C discharge). The cell according to Example 5 using 0.5 wt % of the additive exhibited good rate capability at high rates (0.5 C charge/1.0 C discharge, 0.5 C charge/2.0 C discharge).

### Measurement for DC-IR

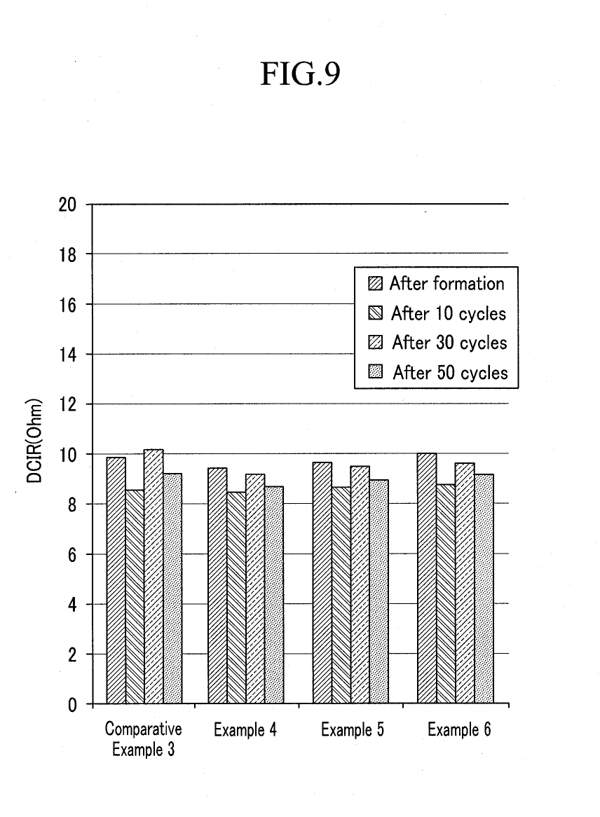

Direct current internal resistance (DC-IR) for the cells according to Examples 4 to 6 and Comparative Example 3 were measured. The results are shown in FIG. 9. The measurement for DC-IR was performed by charging and discharging at 1 C for 50 cycles after formation at 0.5 C twice. The results after formation, after 10 charge-discharge cycles, after 30 charge-discharge cycles, and after 50 charge-discharge cycles are shown in FIG. 9. As shown in FIG. 9, the cell according to Comparative Example 3 exhibits a large change of the DC-IR, but the cells according to Examples 4 to 6 using the additive rarely exhibit changes of the DC-IR. In particular, the cell according to Example 5 using 0.5 wt % of the additive exhibits the smallest change of DC-IR.

While this disclosure has been described in connection with what is presently considered to be practical example embodiments, it is to be understood that the embodiments are not limited to the disclosed embodiments, but, on the contrary, is intended to cover various modifications and equivalent arrangements included within the spirit and scope of the appended claims.

What is claimed is:

1. An electrolyte for a secondary lithium battery comprising an additive represented by Formula 1: 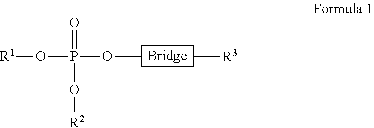
wherein R¹ and R² are each independently a substituted or unsubstituted alkyl group; a substituted or unsubstituted aromatic group; a halogen; a carbonyl group; an amine group; or a fluoroalky group,
Bridge is a substituted or unsubstituted C₂ to C₆ alkylene group; a substituted or unsubstituted C₅ to C₈ cycloalkylene group; or a substituted or unsubstituted aromatic group, and
R³ is CN; CON(R⁴)₂; or CONHR⁵,
wherein R⁴ and R⁵ are each independently a substituted or unsubstituted alkyl group; a substituted or unsubstituted aromatic group; a halogen; a carbonyl group; an amine group; or a fluoroalkyl group.

2. The electrolyte of claim 1, wherein R³ is CN.

3. The electrolyte of claim 1, wherein R¹ and R² are each independently a methyl group or a trifluoromethyl group.

4. The electrolyte of claim 1, wherein R⁴ and R⁵ are each independently a methyl group or a difluoromethyl group.

5. The electrolyte of claim 1, further comprising vinylethyl carbonate, vinylene carbonate, or an ethylene carbonate-based compound of the following Formula 3: 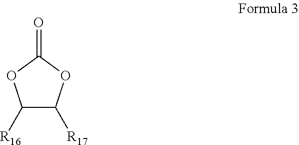
wherein R₁₆ and R₁₇ are each independently selected from the group consisting of hydrogen, a halogen, a cyano group (CN), a nitro group (NO₂), and a fluorinated C₁ to C₅ alkyl group, and
wherein at least one of R₁₆ and R₁₇ is selected from the group consisting of a halogen, a cyano group (CN), a nitro group (NO₂), and a fluorinated C₁ to C₅ alkyl group.

6. The electrolyte of claim 1, wherein Bridge is tetramethylethylene, trifluoromethyltrimethylethylene, tetratrifluoromethylethylene or a combination thereof.

7. The electrolyte of claim 1, wherein Bridge is tetramethylethylene.

8. The electrolyte of claim 1, wherein the additive is 1-cyano-1,1,2,2-tetramethy dimethyl phosphate, 1-cyano-1,1,2,2-tetratrifluoromethyl dimethyl phosphate, 1-cyano-1,1-dimethyl-2,2-(trifluoromethyl) dimethyl phosphate, 1-cyano-1,1-di(trifluoromethyl)-2,2-dimethyl dimethyl phosphate or a combination thereof.

9. The electrolyte of claim 1, wherein an amount of the additive is from about 0.05 wt % to about 5 wt % based on the total weight of the electrolyte.

10. The electrolyte of claim 1, wherein an amount of the additive is from about 0.1 wt % to about 2 wt % based on the total weight of the electrolyte.

11. A secondary lithium battery comprising:
a negative electrode comprising a negative active material;
a positive electrode comprising a positive active material; and
an electrolyte comprising an additive represented by Formula 1: 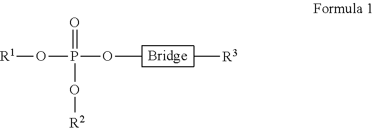
wherein R¹ and R² are each independently a substituted or unsubstituted alkyl group; a substituted or unsubstituted aromatic group; a halogen; a carbonyl group; an amine group; or a fluoroalky group,
Bridge is a substituted or unsubstituted C₂ to C₆ alkylene group; a substituted or unsubstituted C₅ to C₈ cycloalkylene group; or a substituted or unsubstituted aromatic group, and
R³ is CN; CON(R⁴)₂; or CONHR⁵,
wherein R⁴ and R⁵ are each independently a substituted or unsubstituted alkyl group; a substituted or unsubstituted aromatic group; a halogen; a carbonyl group; an amine group; or a fluoroalkyl group.

12. The secondary lithium battery of claim 10, wherein R³ is CN.

13. The secondary lithium battery of claim 10, wherein R¹ and R² are each independently a methyl group or a trifluoromethyl group.

14. The secondary lithium battery of claim 10, wherein R⁴ and R⁵ are each independently a methyl group or a difluoromethyl group.

15. The secondary lithium battery of claim 10, wherein the electrolyte further comprises vinylethyl carbonate, vinylene carbonate, or an ethylene carbonate-based compound of the following Formula 3: 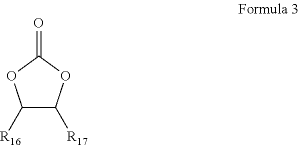
wherein R₁₆ and R₁₇ are each independently selected from the group consisting of hydrogen, a halogen, a cyano group (CN), a nitro group (NO₂), and a fluorinated C₁ to C₅ alkyl group, and
wherein at least one of R₁₆ and R₁₇ is selected from the group consisting of a halogen, a cyano group (CN), a nitro group (NO₂), and a fluorinated C₁ to C₅ alkyl group.

16. The secondary lithium battery of claim 10, wherein Bridge is tetramethylethylene, trifluoromethyltrimethylethylene, tetratrifluoromethylethylene or a combination thereof.

17. The secondary lithium battery of claim 10, wherein Bridge is tetramethylethylene.

18. The secondary lithium battery of claim 10, wherein the additive is 1-cyano-1,1,2,2-tetramethy dimethyl phosphate, 1-cyano-1,1,2,2-tetratrifluoromethyl dimethyl phosphate, 1-cyano-1,1-dimethyl-2,2-(trifluoromethyl) dimethyl phosphate, 1-cyano-1,1-di(trifluoromethyl)-2,2-dimethyl dimethyl phosphate or a combination thereof.

19. The secondary battery of claim 10, wherein the additive is from about 0.05 wt % to about 5 wt % based on the total weight of the electrolyte.

20. The secondary battery of claim 10, wherein the additive is from about 0.1 wt % to about 2 wt % based on the total weight of the electrolyte.
